(19) United States
(12) Patent Application Publication
(10) Pub. No.: US 2016/0088187 A1
(43) Pub. Date: Mar. 24, 2016

(54) DATA PROCESSING APPARATUS, DATA PROCESSING METHOD, AND NON-TRANSITORY COMPUTER READABLE MEDIUM

(71) Applicant: FUJI XEROX CO., LTD., Tokyo (JP)

(72) Inventors: Daisuke MATSUMOTO, Kanagawa (JP); Junichi OKUYAMA, Kanagawa (JP)

(21) Appl. No.: 14/606,583

(22) Filed: Jan. 27, 2015

(30) Foreign Application Priority Data
Sep. 19, 2014 (JP) 2014-191520

(51) Int. Cl. H04N 1/40; H04N 1/00; H04N 1/21

(52) U.S. Cl. CPC H04N 1/40062; H04N 1/21; H04N 1/00954; H04N 2201/214

(57) ABSTRACT

A data processing apparatus includes a determination unit and a selection unit. The determination unit determines whether or not it is necessary to regulate an amount of data in accordance with a condition related to a data storage margin. The selection unit selects data processing for regulating from among plural data processing candidates by comparing amounts of data resulting from the plural data processing candidates with one another in a case where it is necessary to regulate an amount of data.

### CROSS-REFERENCE TO RELATED APPLICATIONS

This application is based on and claims priority under 35 USC 119 from Japanese Patent Application No. 2014-191520 filed Sep. 19, 2014.

### BACKGROUND

(i) Technical Field

The present invention relates to a data processing apparatus, a data processing method, and a non-transitory computer readable medium.

(ii) Related Art

There are data processing apparatuses that perform data processing, for example, image processing, on data. Some apparatuses related to data processing such as image processing have hitherto been proposed.

### SUMMARY

According to an aspect of the invention, there is provided a data processing apparatus including a determination unit and a selection unit. The determination unit determines whether or not it is necessary to regulate an amount of data in accordance with a condition related to a data storage margin. The selection unit selects data processing for regulating from among plural data processing candidates by comparing amounts of data resulting from the plural data processing candidates with one another in a case where it is necessary to regulate an amount of data.

### BRIEF DESCRIPTION OF THE DRAWINGS

An exemplary embodiment of the present invention will be described in detail based on the following figures, wherein:

FIG. 1 illustrates a specific example of a data processing apparatus suitably used in an exemplary embodiment of the present invention;

FIGS. 2A and 2B illustrate examples in which raster image processing and vector image processing are compared with each other;

FIGS. 3A and 3B describe specific examples of units of processing when an amount of data is regulated;

FIGS. 4A and 4B illustrate a specific example of a process performed by the data processing apparatus illustrated in FIG. 1;

FIG. 5 is a diagram illustrating a specific example of an amount of accumulated data and a memory margin;

FIG. 6 illustrates a specific example related to processing in units of lines;

FIG. 7 illustrates a specific example related to processing in units of objects; and

FIG. 8 illustrates a specific example of results of image processing.

### DETAILED DESCRIPTION

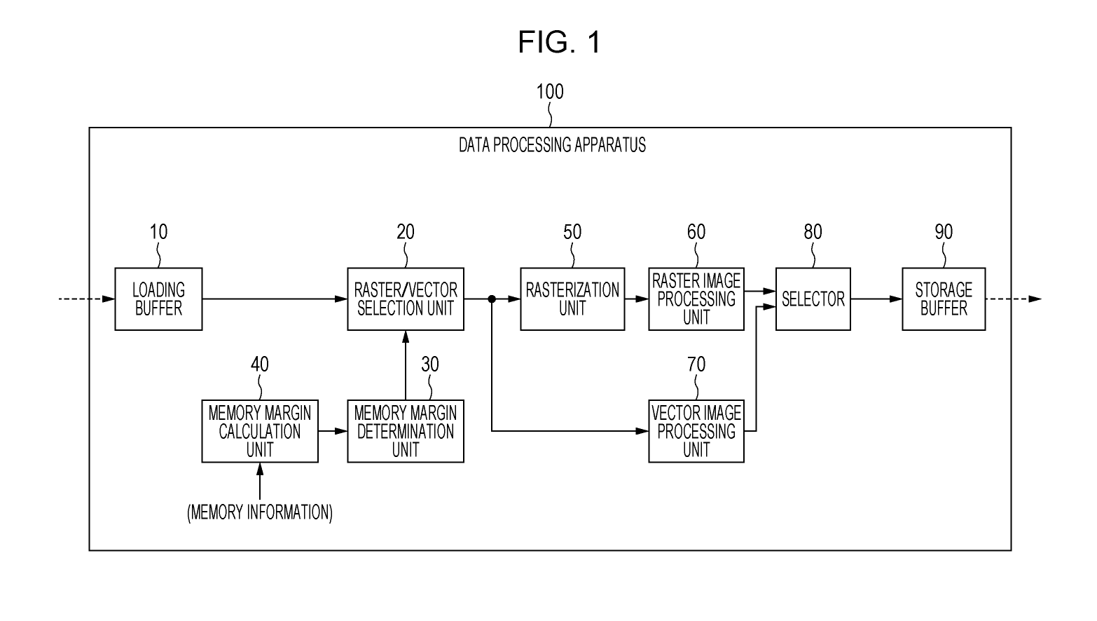

FIG. 1 illustrates a specific example of a data processing apparatus 100 suitably used in an exemplary embodiment of the present invention. The data processing apparatus 100 illustrated in FIG. 1 performs data processing on processing-target data. A specific example of processing-target data is image data (including data composed of text, numerals, or signs alone). For example, image data is sent to a loading buffer 10 of the data processing apparatus 100 from an external apparatus, such as a computer, via a data bus (not illustrated) or the like.

The data processing apparatus 100 illustrated in FIG. 1 may be included in an image processing apparatus having a function such as an image scanning function. Image data obtained from a medium such as paper by using the image scanning function may be input to the loading buffer 10. Further, image data that has been processed by the data processing apparatus 100 may be output from a storage buffer 90. An image based on the processed image data may be printed on paper or the like or may be provided to an external apparatus. In this way, an image processing apparatus may be implemented by using the data processing apparatus 100 illustrated in FIG. 1.

Specific examples of data processing performed by the data processing apparatus 100 illustrated in FIG. 1 include image processing such as gamma correction, RGB-CMYK conversion, nozzle misfiring correction, and screening. In addition, data processing such as matrix calculation and data compression may be performed.

As for image processing performed on processing-target image data (e.g., data of an intermediate language), the data processing apparatus 100 illustrated in FIG. 1 has a function for implementing the image processing using raster data after rasterizing image data into the raster data and a function for implementing the image processing using vector data without rasterizing image data.

A raster/vector selection unit 20 selects raster image processing or vector image processing as processing to be used in the image processing performed on image data obtained from the loading buffer 10.

A memory margin determination unit 30 determines whether or not it is necessary to regulate an amount of data by referring to a margin (hereinafter, also referred to as a memory margin) of a memory in which image data that has undergone the image processing is stored.

A memory margin calculation unit 40 calculates a memory margin on the basis of memory information regarding the memory in which image data that has undergone the image processing is stored.

In the case where raster image processing is applied to image data, a rasterization unit 50 rasterizes the image data into raster data. A raster image processing unit 60 performs raster image processing on the raster data, which has been rasterized from the image data, and obtains resulting image data. The resulting image data obtained by the raster image processing unit 60 is then sent to the storage buffer 90 via a selector 80.

In the case where vector image processing is applied to image data, a vector image processing unit 70 performs vector image processing on the image data and obtains resulting image data. Specific examples of the vector image processing performed by the vector image processing unit 70 include processing for converting data in accordance with a predetermined rule, for example, data processing based on the Joint Photographic Experts Group (JPEG) standard, the Huffman coding, or the run-length vector. The resulting image data obtained by the vector image processing unit 70 is then sent to the storage buffer 90 via the selector 80.

Image data is merely one specific example that may be suitably processed by the data processing apparatus 100 illustrated in FIG. 1 and the data processing apparatus 100 illustrated in FIG. 1 may process data other than image data.

The data processing apparatus 100 illustrated in FIG. 1 may be implemented by, for example, a dynamic reconfigurable processor (DRP). Alternatively, the data processing apparatus 100 may be implemented by a programmable logic device (PLD), a field programmable gate array (FPGA), or an application specific integrated circuit (ASIC). The hardware for implementing the data processing apparatus 100 described above is merely an example and the data processing apparatus 100 may be implemented by hardware of another type.

For example, functions of the data processing apparatus 100 illustrated in FIG. 1 may be implemented by a computer. In the case where the data processing apparatus 100 is implemented by a computer, a program corresponding to a process performed by each unit (to be described in detail later) of the data processing apparatus 100 is, for example, stored on a computer readable storage medium such as a disc or a memory and is provided to the computer via the computer readable storage medium. Alternatively, the program may be provided to the computer via an electrical communication line such as the Internet. Hardware resources such as a central processing unit (CPU) and a memory of the computer operate in cooperation with the provided program (software), so that functions of the data processing apparatus 100 are implemented.

The overview of the data processing apparatus 100 illustrated in FIG. 1 is as described above. A specific example of processes performed by the respective units of the data processing apparatus 100 illustrated in FIG. 1 will be described next. As for the components (units assigned reference signs) illustrated in FIG. 1, the reference signs used in FIG. 1 are also used in the following description.

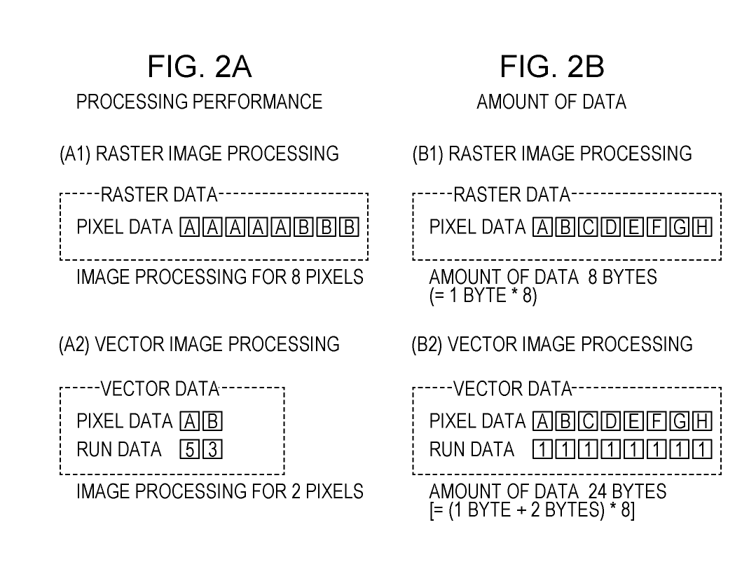

FIGS. 2A and 2B illustrate examples in which raster image processing and vector image processing are compared with each other. FIG. 2A illustrates an example in which raster image processing (A1) and vector image processing (A2) are compared in terms of processing performance.

In the raster image processing (A1), image data is rasterized into raster data. For example, as in a specific example illustrated in (A1), image data is rasterized into raster data constituted by multiple pixel data items arranged in the order of “AAAAABBB”.

In the raster image processing (A1), image processing is performed on the multiple pixel data items that constitute the raster data on a pixel-data-item basis. For example, in the specific example of the raster data illustrated in (A1), image processing is performed for eight pixels.

In contrast, in the vector image processing (A2), image data is not rasterized into raster data. Instead, vector data including a run data item of “5” which corresponds to a pixel data item of “A” and a run data item of “3” which corresponds to a pixel data item of “B” is processed in a specific example illustrated in (A2), for example. A run data item indicates a length of a run of a pixel data item (i.e., a run length). For example, the specific example of the vector data illustrated in (A2) indicates that the image data item of “A” is consecutively arranged for five pixels and the image data item of “B” is consecutively arranged for three pixels. That is, the vector data of (A2) and the raster data of (A1) correspond to identical image data.

In the vector image processing (A2), image processing is performed on each of the pixel data items that constitute the vector data and the results of the image processing are utilized as many times as the run lengths indicated by the run data items for the pixel data items. For example, in the specific example of the vector data illustrated in (A2), image processing is performed for two pixels, that is, the pixel data items of “A” and “B”. The result obtained through the image processing on the pixel data item of “A” is copied for five pixels and the result obtained through the image processing on the pixel data item of “B” is copied for three pixels.

As described above, in the specific example illustrated in FIG. 2A, image processing is performed for eight pixels in the raster image processing (A1), whereas image processing is performed only for two pixels in the vector image processing (A2). Accordingly, the speed of the vector image processing (A2) may be four times higher than that of the raster image processing (A1).

FIG. 2B illustrates an example in which raster image processing (B1) and vector image processing (B2) are compared with each other in terms of an amount of data.

In the raster image processing (B1), image data is rasterized into raster data. For example, as in a specific example illustrated in (B1), image data is rasterized into raster data constituted by multiple pixel data items arranged in the order of “ABCDEFGH”. For example, when an amount of data for each pixel data item is equal to 1 byte, an amount of data for the raster data is equal to 8 bytes in the specific example illustrated in (B1).

In contrast, in the vector image processing (B2), vector data constituted by each pixel data item and its corresponding run data item is used. For example, as in a specific example illustrated in (B2), vector data constituted by multiple pixel data items arranged in the order of “ABCDEFGH” and run data items each corresponding to one of the pixel data items is processed. The vector data of (B2) and the raster data of (B1) correspond to identical image data. For example, when an amount of data for one pixel data item is equal to 1 byte and an amount of data for one run data item is equal to 2 bytes, an amount of data for the vector data is equal to 24 bytes in the specific example illustrated in (B2).

In the specific example illustrated in FIG. 2B, an amount of data for the raster data handled in the raster image processing (B1) is equal to 8 bytes, whereas an amount of data for the vector data handled in the vector image processing (B2) is equal to 24 bytes. Accordingly, the vector image processing (B2) makes the amount of data greater than that of the raster image processing (B1).

As described above, the vector image processing may be superior to the raster image processing in terms of processing performance (i.e., processing speed) but may increase the amount of data in some cases.

Accordingly, the data processing apparatus 100 illustrated in FIG. 1 selectively uses raster image processing and vector image processing so as to maximize a processing performance (e.g., a processing speed) while guaranteeing an amount of data not to increase too much.

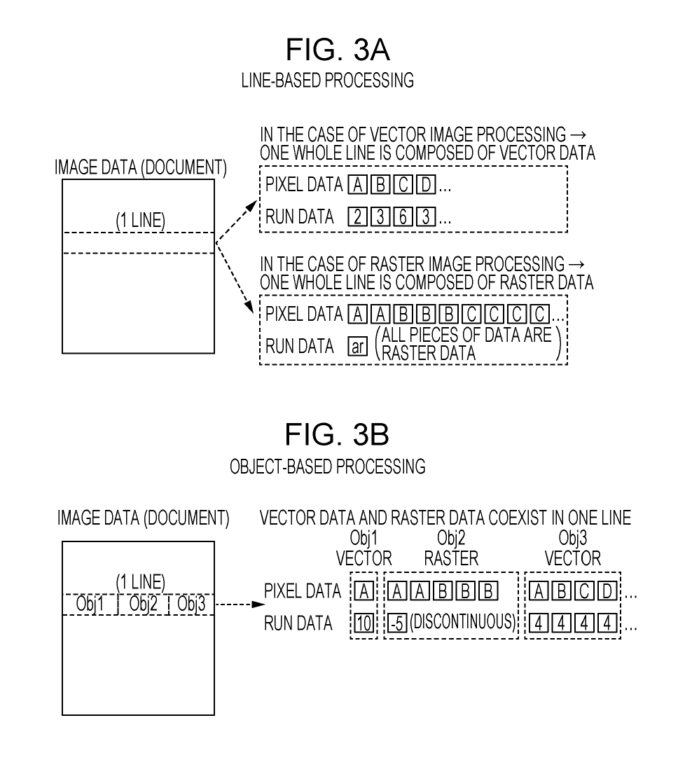

FIGS. 3A and 3B describe a specific example of units of processing employed when an amount of data is regulated. Examples of units of processing employed when an amount of data is regulated include units of lines and units of objects.

FIG. 3A illustrates a specific example of processing in units of lines. When image processing is performed on image data (of a document) constituted by multiple lines, vector image processing or raster image processing is selected on a line-by-line basis (for each line) during processing in units of lines.

If the vector image processing is selected in the processing in units of lines, the entire image data that constitutes one line is converted into vector data (i.e., pixel data items and run data items) and the vector image processing is performed on the vector data. If the raster image processing is selected in the processing in units of lines, the entire image data that constitutes one line is rasterized into raster data and the raster image processing is performed on the raster data. In the specific example illustrated in FIG. 3A, raster data is constituted by multiple pixel data items arranged in a line and one run data item (ar). The run data item (ar) functions as a marker indicating that the entire image data that constitutes one line is raster data.

FIG. 3B illustrates a specific example of processing in units of objects. In the processing in units of objects, the vector image processing or the raster image processing is selected on an object-by-object basis within each line (one line). For example, in the specific example illustrated in FIG. 3B, one line includes multiple objects which are objects 1, 2, and 3 (Obj1, Obj2, and Obj3). The vector image processing is selected for the object 1 (Obj1) and the object 3 (Obj3) and the raster image processing is selected for the object 2 (Obj2).

In the specific example illustrated in FIG. 3B, raster data of the object 2 (Obj2) is constituted by multiple pixel data items arranged in a line and one run data item. This run data item functions as a marker indicating that image data of the object 2 (Obj2) is raster data. In the specific example illustrated in FIG. 3B, the run data item of the object 2 (Obj2) is “−5”, which indicates that five pixel data items are not consecutive (not vector data).

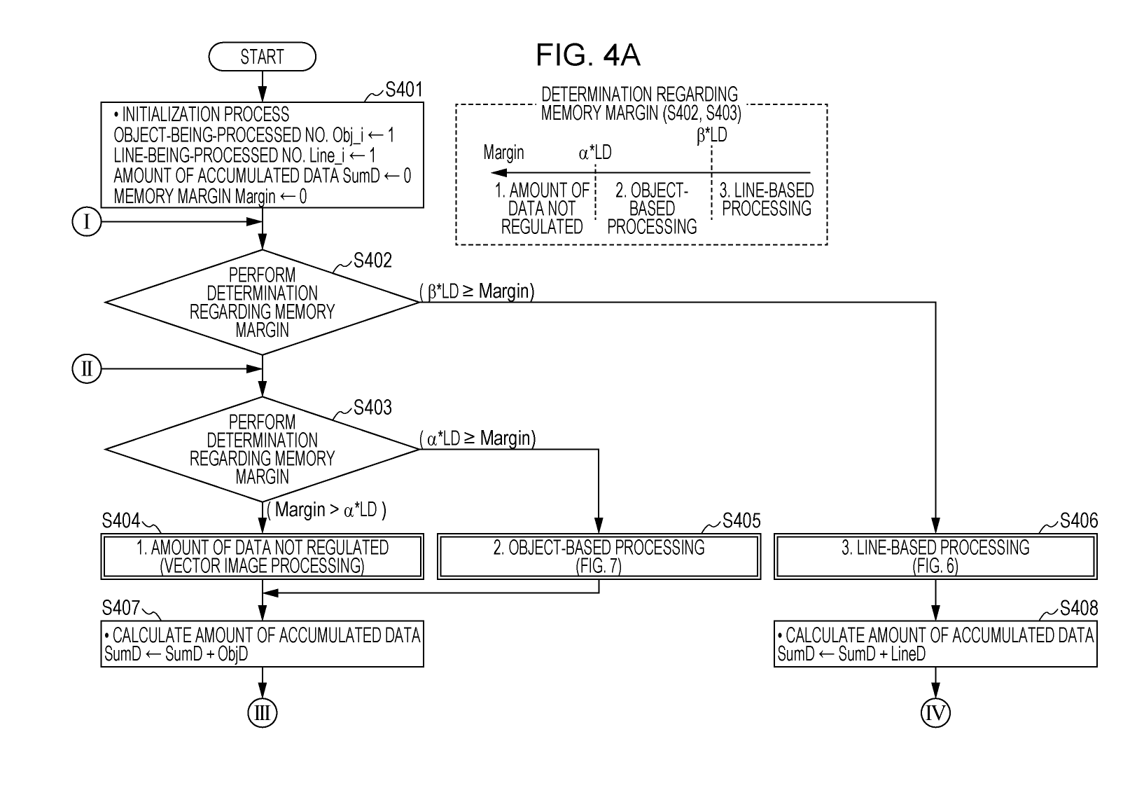

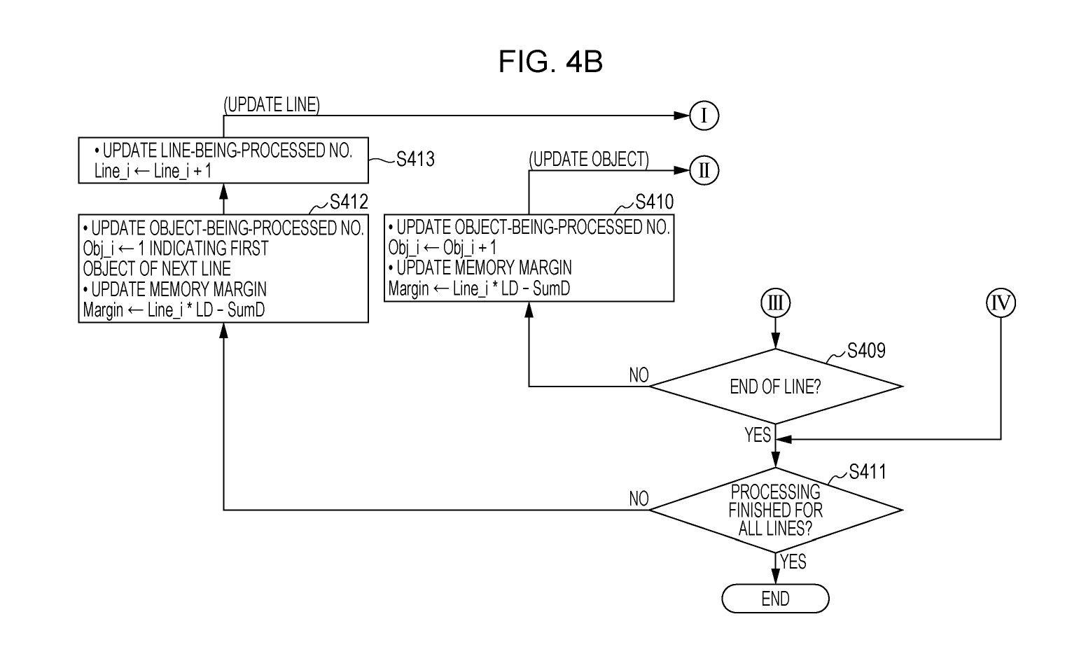

FIGS. 4A and 4B illustrate a specific example of a process performed by the data processing apparatus 100 illustrated in FIG. 1. Before performing data processing such as image processing, the data processing apparatus 100 performs an initialization process (S401). In this initialization process, multiple parameters used in subsequent processes are initialized. Examples of the parameters include an “object-being-processed No.” indicating an object that is being processed, a “line-being-processed No.” indicating a line that is being processed, an “amount of accumulated data” indicating an amount of data that has been subjected to image processing and that is stored in a memory, and a “memory margin” indicating a data storage margin of a memory.

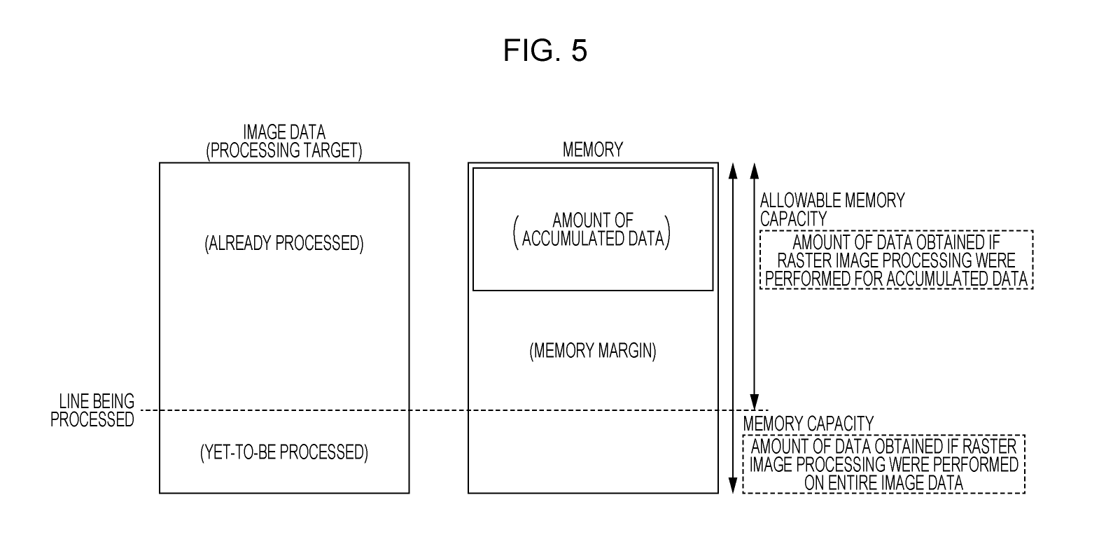

FIG. 5 illustrates a specific example of an amount of accumulated data and a memory margin. FIG. 5 illustrates image data to be subjected to image processing performed by the data processing apparatus 100 and a memory that stores data obtained as a result of the image processing on the image data (i.e., data output from the storage buffer 90). The memory may be included in the data processing apparatus 100 or in another apparatus.

A storage capacity of the memory (i.e., a memory capacity) is set equal to an amount of image data for one image, for example. Specifically, the memory capacity is set equal to a capacity that enables storage of data obtained if raster image processing were performed on the entire image data.

Image processing is performed on image data sequentially from the first line to the last line. For example, in the specific example illustrated in FIG. 5, image processing is performed sequentially from the topmost line to the bottommost line. FIG. 5 illustrates a line being processed which is currently subjected to processing. That is, image processing has already been performed on multiple lines (processed lines) on the upper side of the line being processed, image processing is being performed on the line being processed, and image processing is yet to be performed on multiple lines (yet-to-be-processed lines) on the lower side of the line being processed.

The amount of accumulated data is an amount of data that has been subjected to image processing and that is stored in the memory. That is, the amount of accumulated data is an amount of resulting data of image processing performed on the processed lines in the image data. An allowable memory capacity is a capacity available for processing up to the line being processed and is equal to an amount of data obtained if raster image processing were performed on all the processed lines, that is, an amount of data obtained if rasterization were performed.

Specifically, let “LD” denote an amount of data obtained when image data of one line is rasterized into raster data. The allowable memory capacity after image processing has been finished up to the line being processed is calculated by multiplying the “line-being-processed No.” by “LD” (the “line-being-processed No.”×the “LD”).

As described in detail later, the data processing apparatus 100 illustrated in FIG. 1 appropriately selects the vector image processing or the raster image processing in accordance with an amount of data. Thus, the amount of accumulated data is made less than the allowable memory capacity. A difference between the allowable memory capacity and the amount of accumulated data is a memory margin, which is calculated by the memory margin calculation unit 40.

Referring back to FIG. 4A, after the initialization process has been performed in S401, determinations regarding the memory margin are performed in S402 and S403. The memory margin determination unit 30 determines whether or not the memory margin is less than or equal to a first threshold (β×LD) in S402 and determines whether or not the memory margin is less than or equal to a second threshold (α×LD). Here, LD denotes an amount of data obtained for a line when data of the line is rasterized into raster data, and α and β (α>β) are coefficients for the first and second thresholds, respectively. The coefficients α and β may be, for example, experimentally obtained or appropriately adjusted.

Depending on the results of determinations performed regarding the memory margin in S402 and S403, one of steps S404, S405, and S406 is selected. If the memory margin is less than or equal to the first threshold (Margin≦β×LD), the processing in units of lines is performed on the line being processed, that is, the line indicated by the “line-being-processed No.” (S406).

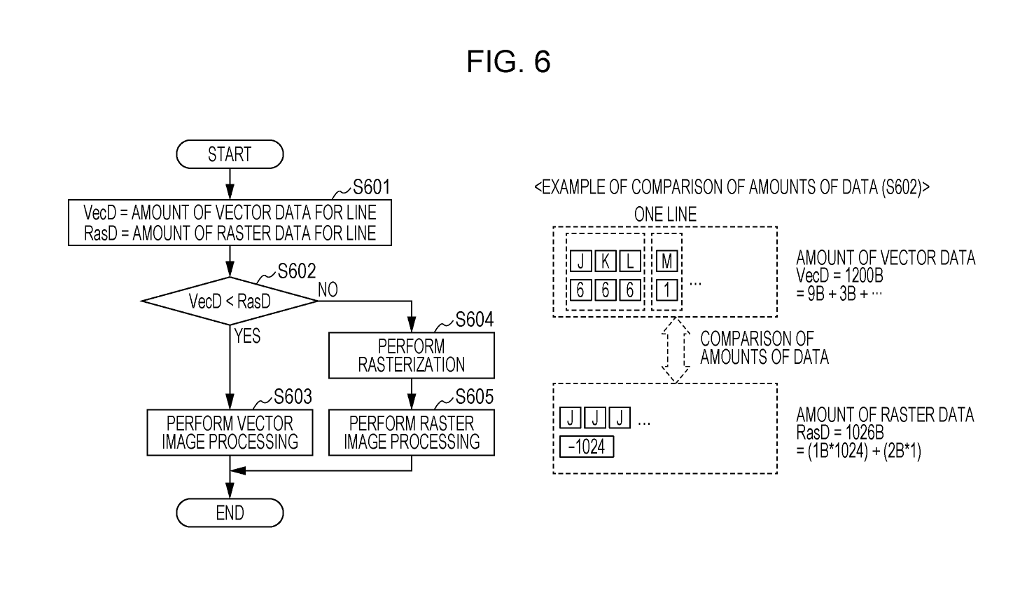

FIG. 6 illustrates a specific example of the processing in units of lines and is a flowchart of the processing in units of lines.

In the processing in units of lines, the raster/vector selection unit 20 calculates an amount of vector data (VecD) obtained if vector image processing were performed on the entire data of the line being processed and an amount of raster data (RasD) obtained if raster image processing were performed on the entire data of the line (S601).

Then, the raster/vector selection unit 20 compares the amount of vector data (VecD) with the amount of raster data (RasD) (S602), and selects one of the vector image processing and the raster image processing that produces the smaller amount of data. Specifically, if the amount of vector data (VecD) is smaller than the amount of raster data (RasD), the vector image processing is selected, and the vector image processing unit 70 performs vector image processing on the line being processed (S603). If the amount of raster data (RasD) is smaller than the amount of vector data (VecD), the raster image processing is selected, and the raster image processing unit 60 performs raster image processing (S605) after the rasterization unit 50 rasterizes the line being processed into raster data (S604). If the amount of raster data (RasD) is equal to the amount of vector data (VecD), it is desirable to select vector image processing; however, raster image processing may be selected.

FIG. 6 illustrates an example in which the amount of vector data is compared with the amount of raster data in the processing in units of lines. In the example illustrated in FIG. 6, the amount of vector data (VecD) is equal to 1200 bytes and the amount of raster data (RasD) is equal to 1026 bytes. Accordingly, in this example, the raster image processing is selected.

Referring back to FIG. 4A, after the processing in units of lines has been finished in S406, that is, after image processing has been finished on the line corresponding to the “line-being-processed No.” which indicates the target being processed, the data processing apparatus 100 calculates the amount of accumulated data (S408). Specifically, the amount of data (LineD) for one line obtained as a result of the image processing performed in S406 is added to the amount of accumulated data (SumD) that has been obtained prior to the image processing in S406. In this way, the amount of accumulated data (SumD) is updated.

Then, the data processing apparatus 100 determines whether the image processing has been finished for all lines of the image data (S411). If the image processing has not been finished for all lines (NO in S411), the data processing apparatus 100 updates the “object-being-processed No.” and the “memory margin” to prepare for image processing for the next line (S412). The data processing apparatus 100 further updates the “line-being-processed No.” (S413). If the image processing has been finished for all lines of the image data (YES in S411), the image processing for the image data is terminated.

If it is determined that the memory margin is greater than the first threshold (Margin>β×LD) and is less than or equal to the second threshold (Margin≦α×LD) in the determinations performed regarding the memory margin in S402 and S403, the processing in units of objects is performed (S405).

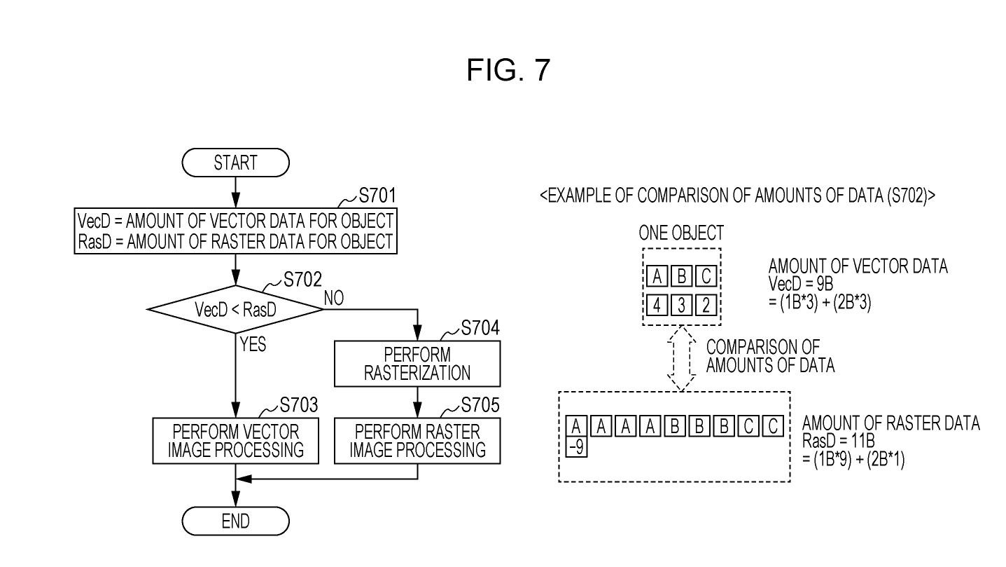

FIG. 7 illustrates a specific example of the processing in units of objects and is a flowchart of the processing in units of objects.

In the processing in units of objects, the raster/vector selection unit 20 calculates an amount of vector data (VecD) obtained if vector image processing were performed on the entire data of the object being processed and an amount of raster data (RasD) obtained if raster image processing were performed on the entire data of the object (S701).

Then, the raster/vector selection unit 20 compares the amount of vector data (VecD) with the amount of raster data (RasD) (S702), and selects one of the vector image processing and the raster image processing that produces the smaller amount of data. Specifically, if the amount of vector data (VecD) is smaller than the amount of raster data (RasD), the vector image processing is selected, and the vector image processing unit 70 performs the vector image processing on the object being processed (S703). If the amount of raster data (RasD) is smaller than the amount of vector data (VecD), the raster image processing is selected, and the raster image processing unit 60 performs raster image processing (S705) after the rasterization unit 50 rasterizes data of the object being processed into raster data (S704). If the amount of raster data (RasD) is equal to the amount of vector data (VecD), it is desirable to select the vector image processing; however, the raster image processing may be selected.

FIG. 7 illustrates an example in which the amount of vector data is compared with the amount of raster data in the processing in units of objects. In the example illustrated in FIG. 7, the amount of vector data (VecD) is equal to 9 bytes and the amount of raster data (RasD) is equal to 11 bytes. Accordingly, the vector image processing is selected in this specific example.

Referring back to FIG. 4A, after the processing in units of objects has been finished in S405, that is, after image processing has been finished for the object indicated by the “object-being-processed No.” which indicates the target being processed, the data processing apparatus 100 calculates the amount of accumulated data (S407). Specifically, the amount of data (ObjD) for one object obtained as a result of the image processing performed in S405 is added to the amount of accumulated data (SumD) that has been obtained prior to the image processing in S405. In this way, the amount of accumulated data (SumD) is updated.

Then, the data processing apparatus 100 determines whether or not the end of the line indicated by the “line-being-processed No.” which indicates the target being processed has been reached (S409). If the end of the line has not been reached (NO in S409), the “object-being-processed No.” and the “memory margin” are updated to prepare for image processing for the next object in the line (S410). If the end of the line has been reached (YES in S409), it is determined whether or not image processing has been finished for all lines of the image data (S411).

If it is determined that the memory margin is greater than the first threshold (Margin>β×LD) and is greater than the second threshold (Margin>α×LD) in the determinations performed regarding the memory margin in S402 and S403, it is determined that the amount of data need not be regulated. Thus, the vector image processing unit 70 performs the vector image processing as the image processing (S404). That is, if the memory margin is greater than the second threshold (Margin>α×LD), the processing performance (e.g., the processing speed) is prioritized over the amount of data, and thus the vector image processing is selected.

After the processing in S404 has been finished, that is, the vector image processing has been finished for the object indicated by the “object-being-processed No.” which indicates the target being processed, the data processing apparatus 100 calculates the amount of accumulated data (S407). Specifically, the amount of data (ObjD) for one object obtained as a result of the vector image processing performed in S404 is added to the amount of accumulated data (SumD) that has been obtained prior to the processing in S404. In this way, the amount of accumulated data (SumD) is updated.

Then, the data processing apparatus 100 determines whether or not the end of the line indicated by the “line-being-processed No.” which indicates the target being processed has been reached (S409). If the end of the line has not been reached (NO in S409), the data processing apparatus 100 updates the “object-being-processed No.” and the “memory margin” to prepare for image processing for the next object within the line (S410). If the end of the line has been reached (YES in S409), it is determined whether or not image processing has been finished for all lines of the image data (S411).

After the image processing has been finished for all lines of the image data (YES in S411) through the process described above, the image processing on the image data ends.

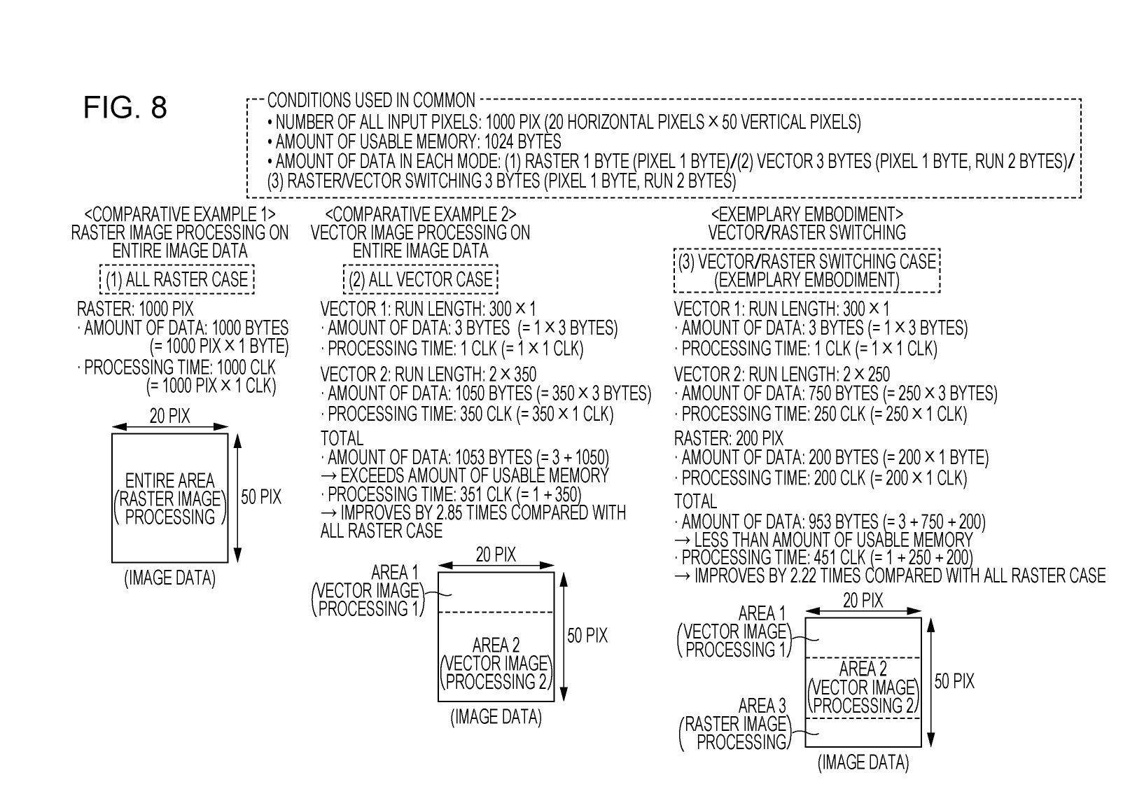

FIG. 8 illustrates a specific example of results of the image processing. Specifically, FIG. 8 illustrates a specific example of image processing results obtained in the case where processing-target image data is constituted by 1000 pixels (20 horizontal pixels×50 vertical pixels) and the memory capacity is 1024 bytes.

A first comparative example illustrated in FIG. 8 gives a processing result obtained when raster image processing is performed for the entire area of the image data. Suppose that the amount of data for each pixel that constitutes raster data is 1 byte and a processing time taken for each pixel is 1 clock (clk). The amount of data for the entire image data is equal to 1000 bytes and the processing time taken for the entire image data is equal to 1000 clocks (clk) in the first comparative example.

A second comparative example illustrated in FIG. 8 gives a processing result obtained when vector image processing is performed for all areas of the image data. That is, the second comparative example gives a result of processing obtained when vector image processing 1 is performed for an area 1 of the image data and vector image processing 2 is performed for an area 2 of the image data.

It is assumed that a run length (i.e., a length of a sequence of pixel data items indicated by a run data item) of vector data in the vector image processing 1 is equal to 300 and the number of vector data items is 1. It is also assumed that a run length of vector data in the vector image processing 2 is equal to 2 and the number of vector data items is 350.

It is further assumed that an amount of data for each pixel data item that constitutes the vector data is equal to 1 byte and an amount of data for each run data item is equal to 2 bytes. That is, an amount of data for one vector data item is equal to 3 bytes. It is also assumed that the processing time taken for image processing on one vector data item is equal to 1 clock (clk). In this case, the amount of data obtained from the vector image processing 1 on the area 1 is equal to 3 bytes and the processing time is equal to 1 clock (clk). The amount of data obtained from the vector image processing 2 on the area 2 is equal to 1050 bytes and the processing time is equal to 350 clocks (clk).

Accordingly, the amount of data obtained for the entire image data in the second comparative example illustrated in FIG. 8 is equal to 1053 bytes and the processing time for the entire image data is equal to 351 clocks (clks). The processing time improves approximately by 2.85 times in the second comparative example compared with that of the first comparative example; however, the amount of data obtained in the second comparative example is 1053 bytes and exceeds the memory capacity of 1024 bytes.

In contrast, the exemplary embodiment illustrated in FIG. 8 gives a result of processing obtained by the data processing apparatus 100 illustrated in FIG. 1, that is, a result of processing obtained in the case where the vector image processing and the raster image processing are appropriately performed in a switching manner on the image data such that vector image processing 1 and vector image processing 2 are respectively performed for areas 1 and 2 and raster image processing is performed for an area 3.

It is assumed that a run length of vector data in the vector image processing 1 is equal to 300 and the number of vector data items is 1. It is also assumed that a run length of vector data in the vector image processing 2 is equal to 2 and the number of vector data items is 250.

It is further assumed that an amount of data for each pixel data item that constitutes the vector data is equal to 1 byte and an amount of data for each run data item is equal to 2 bytes. That is, an amount of data for one vector data item is equal to 3 bytes. It is also assumed that the processing time taken for image processing on one vector data item is equal to 1 clock (clk). In this case, the amount of data obtained from the vector image processing 1 on the area 1 is equal to 3 bytes and the processing time is equal to 1 clock (clk). The amount of data obtained from the vector image processing 2 on the area 2 is equal to 750 bytes and the processing time is equal to 250 clocks (clk). Suppose that the amount of data of each pixel that constitutes the raster data is equal to 1 byte and the processing time taken for each pixel of raster data is equal to 1 clock (clk). The amount of data obtained in raster image processing on the area 3 is equal to 200 bytes and the processing time is equal to 200 clocks (clk).

Accordingly, the amount of data obtained for the entire image data in the exemplary embodiment illustrated in FIG. 8 is equal to 953 bytes and the processing time taken for the entire image data is 451 clocks (clk). The processing time improves by approximately 2.22 times in the exemplary embodiment illustrated in FIG. 8 compared with that of the first comparative example and the amount of data is equal to 953 bytes and may be suppressed to be less than the memory capacity of 1024 bytes.

As described above, the data processing apparatus 100 illustrated in FIG. 1 increases the data processing speed while guaranteeing an amount of data not to exceed the memory capacity.

While the exemplary embodiment of the present invention has been described above, the above-described exemplary embodiment is merely illustrative in all respects and does not limit the scope of the present invention. The present invention encompasses various modifications made within the scope not departing from the spirit thereof.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data processing apparatus comprising:
a determination unit that determines whether or not it is necessary to regulate an amount of data in accordance with a condition related to a data storage margin; and
a selection unit that selects data processing for regulating from among a plurality of data processing candidates by comparing amounts of data resulting from the plurality of data processing candidates with one another in a case where it is necessary to regulate an amount of data.

2. The data processing apparatus according to claim 1, wherein the determination unit determines that it is necessary to regulate an amount of data in a case where the data storage margin is less than or equal to a certain amount and does not satisfy the condition.

3. The data processing apparatus according to claim 1, wherein
the determination unit determines that it is not necessary to regulate an amount of data in a case where the data storage margin is greater than a certain amount and satisfies the condition, and
the selection unit selects data processing from among the plurality of data processing candidates by prioritizing processing performance over the amount of data resulting from each of the plurality of data processing candidates in a case where it is not necessary to regulate an amount of data.

4. The data processing apparatus according to claim 1, wherein
the plurality of data processing candidates include standard-performance data processing and high-performance data processing that achieves a performance higher than that achieved by the standard-performance data processing, and
the selection unit selects, as the data processing for regulating, data processing that produces a smaller amount of data from among the standard-performance data processing and the high-performance data processing or one of the plurality of data processing candidates that produces a smaller amount of data than the standard-performance data processing and the high-performance data processing in a case where it is necessary to regulate an amount of data.

5. The data processing apparatus according to claim 1, wherein
the plurality of data processing candidates include standard-performance data processing and high-performance data processing that achieves a performance higher than that achieved by the standard-performance data processing, and
the selection unit selects the high-performance data processing in a case where it is not necessary to regulate an amount of data.

6. The data processing apparatus according to claim 1, wherein
it is guaranteed that an amount of data resulting from data processing does not to exceed a storage capacity available for the data processing by referring to, as the data storage margin, a free space of the storage capacity.

7. A data processing method comprising:
determining whether or not it is necessary to regulate an amount of data in accordance with a condition related to a data storage margin; and
selecting data processing for regulating from among a plurality of data processing candidates by comparing amounts of data resulting from the plurality of data processing candidates with one another in a case where it is necessary to regulate an amount of data.

8. A non-transitory computer readable medium storing a program causing a computer to execute a process for data processing, the process comprising:
determining whether or not it is necessary to regulate an amount of data by referring to a data storage margin; and
selecting data processing for regulating from among a plurality of data processing candidates by comparing amounts of data resulting from the plurality of data processing candidates with one another in a case where it is necessary to regulate an amount of data.
